(19) United States
(12) Patent Application Publication
(10) Pub. No.: US 2015/0372357 A1
(43) Pub. Date: Dec. 24, 2015

(54) INTEGRATED MAGNESIUM AIR CELL AND CATHODES

(71) Applicants: Ivan Theodore Kruglak, Boulder, CO (US); Mark Dansie, San Jose Del Monte (PH); James Rodney, Grass Valley, CA (US); Hugh P. Adamson, Boulder, CO (US)

(72) Inventors: Ivan Theodore Kruglak, Boulder, CO (US); Mark Dansie, San Jose Del Monte (PH); James Rodney, Grass Valley, CA (US); Hugh P. Adamson, Boulder, CO (US)

(21) Appl. No.: 14/312,458

(22) Filed: Jun. 23, 2014

(51) Int. Cl. H01M 12/06; H01M 12/02; H01M 16/00; H01M 8/02

(52) U.S. Cl. CPC H01M 12/06; H01M 8/0273; H01M 8/0278; H01M 12/02; H01M 16/003; H01M 2250/30; H01M 2220/30

(57) ABSTRACT

A magnesium fuel cell with removable anodes and cathodes wherein the cathodes are enclosed in flat or curved frames or fixtures that are easily replaceable when damaged. The cathodes are designed to be particularly durable for heavy use. Multiple redundancies are incorporated that make the fuel cell less likely to fail and more suitable for use in places where other power sources are not available. The fuel cell is adapted for long use at low voltage levels and with a secondary battery with higher voltage that is continuously charged that in turn, can be used to charge other batteries.

### BACKGROUND OF THE DISCLOSURE

1. Technical Field of the Disclosure

The present embodiment relates to fuel cells in general. More specifically, the present embodiment relates to an integrated Magnesium-Oxygen fuel cell (abbreviated Mg-air) having removable and highly durable cathodes and associated wiring. Fuel cells are different from batteries in that they require a continuous source of fuel and oxygen/air to sustain the chemical reaction whereas in a battery the chemicals present in the battery react with each other to generate an electromotive force (emf). Fuel cells can produce electricity continuously for as long as a continuous source of fuel and air are supplied.

2. Description of the Related Art

The recent proliferation of personal electronic devices such as smart phones, tablets and laptop computers as well as battery powered flashlights, lanterns, and area lights highlight the need for improved battery technology. The public demands longer usage periods than the existing short usage cycles of these devices. Primary batteries (single use types) and secondary (rechargeable) have been in use since the early 1900s but have not benefited from technology advances to the same extent as semiconductor technology. Even the advanced Lithium technologies featured in the latest portable electronics gear are far from adequate in terms of cycle time, duration of charge, self-discharge, and limited number of recharges. As such, a long-felt need has been experienced in the related art for power sources having improved battery or other technologies to power this multitude of devices. The Magnesium-Air (Mg-air) fuel cell will do this. The current embodiment will outlast approximately 30 Alkaline “AA” cells and larger versions, many more, and can be refuelled very quickly.

A number of different fuel cell technologies exist, but only the Mg-air meets the criteria for easy to use, inexpensive to maintain, replaceable components (in our implementation), readily available, non-toxic electrolyte (salt water) and non-toxic reaction byproducts and also very high power density. Of course, other fuel cell technologies exist. Two of those closest to the Mg-Air technology are as follows: one of the existing fuel cell systems provides a primary aluminum hydride cell formed with a plurality of the cells. The cells are constructed of an anode, a cathode and an aqueous electrolyte. The anode comprises aluminum hydride and a conductive material wherein the anode and cathode are in contact with the electrolyte so as to produce hydrogen protons by way of the discharge reaction during operation of the fuel cell. In some embodiments the cathode comprises an air diffusion cathode. The main drawback of this system is that aluminum hydroxide gets deposited in the cathode and leads to blockage that reduces the cell's lifetime.

Another existing device discloses a sulfur/aluminum fuel cell in which an aluminum anode and an aqueous alkaline/polysulfide electrolytic solution are in direct contact. At high polysulfide concentrations, parasitic chemical reactions between the aluminum and sulfur are minimized, allowing for efficient oxidation of the aluminum anode, and resulting in a fuel cell having high energy and power densities. The downside to this fuel cell is that aluminum anode becomes oxidized and cannot be replaced which leads to fuel cell failure. Other fuel cell technologies exist like Zinc-Air, but are not designed to have replaceable elements and have limited lifetimes.

Therefore, there is a need for a fuel cell that can be used for a longer period of time. Such a needed fuel cell would have a removable cathode that would restore the fuel cell operation in case of a blockage on the cathode. Such a fuel cell would provide a cathode attached to the cell wall or other means to prevent leakage of the electrolyte. This fuel cell would provide a replaceable cathode to avoid deterioration of the cathode lead due to possible electrolysis and would prevent cell failure. Such a needed device would provide the capability to replace the anode that will be consumed in the cell reaction. This fuel cell would use an electrolyte that is abundantly available in nature; also, it would not release any toxic and/or hazardous byproducts into the environment. It would also be highly efficient, with a high energy density, use readily available materials and be very easy to activate and maintain by a layperson. In summary, there is a need for a fuel cell that is inexpensive, simple in construction, and environmentally friendly that provides a constant power source that can be applied to any load. The present disclosure accomplishes all of these objectives.

### SUMMARY

In addressing many of the problems experienced in the related art, such as those relating to conventional primary, secondary batteries and fuel cells, the present disclosure generally involves devices, such as a magnesium-air (Mg-air) fuel cell (integrated) as a power source for electronic devices, such as flashlights, lanterns, radios, handheld devices, laptop computers, e.g., having a charger and/or power module features. The devices and methods also involve operation of the Mg-air fuel cell as well as direct-current-to-direct-current (DC-DC) converters for boosting the low cell voltage to useful levels, in accordance with the present disclosure. The lighting devices, such as flashlight cases, comprise anode members having a quick-connect/disconnect feature as well as other features and operational details. The present disclosure contemplates a method of fabricating a Mg-air fuel cell that is practical, compact, reliable, prevents leakage of electrolytes, and has other additional desirable features for facilitating operation for extended long-term use.

The present disclosure contemplates devices and methods involving a magnesium-air fuel cell, an integrated Mg-air fuel cell, a module comprising a Mg-air fuel cell or an integrated Mg-air fuel cell for charging a high capacity battery, such as a rechargeable battery, e.g., a nickel metal hybrid (NiMH) battery or a lithium (Li) battery, a super-capacitor, also called an ultra-capacitor, various jacks with regulated and unregulated voltage outputs, and a combination thereof, and an electronic device, such as a lighting device, e.g., a lighting device for general illumination, a cellular phone, a laptop computer, and the like. A super-capacitor or an ultra-capacitor provides immediate high-energy charge and discharge. A synergistic device configuration comprises at least one of the foregoing features and is believed to be beneficial and to overcome the limitations of the related art technologies.

In addition, the present disclosure generally involves a fuel cell device as well as its corresponding methods of fabrication and use. The fuel cell device, such as a Mg-air fuel cell, comprises at least one anode member, at least one corresponding cathode member, and an electrolyte solution in fluid communication with the at least one anode member and the at least one corresponding cathode member. The at least one corresponding cathode member generally comprises a carbon sheet formation having a hydrophobic permeable material for facilitating gas exchange and for preventing leakage of the electrolyte solution.

Further, the present disclosure generally involves a power module device as well as its corresponding methods of fabrication and use. The power module device comprises a fuel cell device, the fuel cell device, such as a Mg-air fuel cell, comprising at least one anode member, at least one corresponding cathode member, and an electrolyte solution in fluid communication with the at least one anode member and the at least one corresponding cathode member; and an optional power source or charger. The fuel cell means in this embodiment is best suited for long, low to medium power output such as LED lighting. In order to charge high density Li-ion batteries found in (for example), cell phones, the power module is equipped with NiMh, Li-ion or other high power density rechargeable battery that is trickle charged during ordinary use of the Mg-air cell via additional DC-DC converter means. When the cell phone (in this example), is plugged into the power module, it is then charged by the secondary, high-density battery as well as the Mg-air cell in parallel to expedite charging.

Even further, the present disclosure generally involves a lighted fuel cell device as well as its corresponding methods of fabrication and use. The lighted fuel cell device comprises a fuel cell device, such as a Mg-air fuel cell, the fuel cell device comprising at least one anode member, at least one corresponding cathode member, an electrolyte solution in fluid communication with the at least one anode member and the at least one corresponding cathode member, and at least one illuminating device coupled with the fuel cell device.

Yet even further, the present disclosure generally involves a lighted power module device as well as its corresponding methods of fabrication and use. The lighted power module device comprises a power module device, the power module device comprising a fuel cell device, such as a Mg-air fuel cell, the fuel cell device comprising at least one anode member, at least one corresponding cathode member, and an electrolyte solution in fluid communication with the at least one anode member and the at least one corresponding cathode member, an auxiliary high-capacitance or electrochemical cell device coupled with, and chargeable by, the fuel cell device; and at least one illuminating device coupled with the power module device. The at least one illuminating device generally comprises at least one light-emitting diode (LED) or other high efficiency illumination source.

### OBJECTS AND ADVANTAGES

The present disclosure can provide a number of advantages depending on the particular aspect, embodiment, and/or configuration. None of the particular objects or advantages that follow must be entirely satisfied as they are non-exclusive alternatives and at least one of the following objects is met; accordingly, several objects and advantages of the present invention are:

(a) to provide a fuel cell that has at least one cathode which is replaceable to enable longer use of the fuel cell;

(b) to provide a fuel cell-equivalent that can be used for a longer period of time;

(c) to provide a replaceable cathode to avoid deterioration of the cathode lead due to electrolysis and to prevent cell failure;

(d) to provide a replaceable cathode so that the cell or product containing the cell is not rendered useless due to mechanical failure of the cathode due to puncture by the user while cleaning debris out of the cell;

(e) to provide a fuel cell having a replaceable anode;

(f) to provide a fuel cell that utilizes an electrolyte that is available abundantly in nature;

(g) to provide a fuel cell that has a power module so that different loads can be connected;

(h) to provide a fuel cell system that includes a DC to DC converter to boost the fuel cell voltage to different useful voltage levels;

(i) to provide a fuel cell that does not release any toxic or hazardous byproducts into the environment;

(j) to provide a fuel cell that is inexpensive, simple in construction, environment friendly, and that provides a constant power that can be applied to any load.

These and other objectives and advantages of the instant invention will become apparent from the following description taken in conjunction with the accompanying drawings wherein are set forth, by way of illustration and example, certain embodiments of the instant invention. The drawings are intended to constitute a part of this specification and include exemplary embodiments of the present invention and it various objects and features thereof.

### BRIEF DESCRIPTION OF THE DRAWINGS

The above, and other, aspects, features, and advantages of several embodiments of the present disclosure will be more apparent from the following Detailed Description as presented in conjunction with the following several figures of the Drawing.

In order to enhance the clarity and improve understanding of the various elements and embodiments described below, elements in the figures have not necessarily been drawn to scale. Furthermore, elements that are known to be common and well understood to those in the industry are not depicted in order to provide a clear view of the various embodiments of the invention, thus the drawings are generalized in form in the interest of clarity and conciseness.

FIG. 1 illustrates a cross sectional view of a fuel cell, in accordance with an embodiment of the present disclosure.

FIG. 2 illustrates an exploded view of the fuel cell, with an outer casing shown in FIG. 1 being removed, in accordance with an embodiment of the present disclosure.

FIG. 3 illustrates a partially cut away view of the at least one cathode, in accordance with an embodiment of the present disclosure.

FIG. 4A illustrates an exploded view of a single replaceable cathode assembly, in accordance with an embodiment of the present disclosure.

FIG. 4B illustrates an exploded view of a multiple replaceable cathode assembly, in accordance with an embodiment of the present disclosure.

FIG. 5 illustrates an exploded view of one embodiment of a fuel cell in use with a lantern, in accordance with an embodiment of the present disclosure.

FIG. 6A illustrates a cross-sectional view of an embodiment of the fuel cell in use with a small flashlight, in accordance with an embodiment of the present disclosure.

FIG. 6B illustrates a cross-sectional view of an embodiment of the fuel cell in use with a large flashlight, in accordance with an embodiment of the present disclosure.

FIG. 7 illustrates a perspective view of an embodiment of the fuel cell in use with a lighted power module, in accordance with an embodiment of the present disclosure.

FIGS. 8A-8C illustrates circuit diagrams of a DC-DC convertor to be used for low power, medium power, and high power fuel cell respectively, in accordance with an embodiment of the present disclosure.

### DETAILED DESCRIPTION

The following description is not to be taken in a limiting sense, but is made merely for the purpose of describing the general principles of exemplary embodiments, many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure. Any alterations and further modifications in the illustrated devices, and such further application of the principles of the invention as illustrated herein are contemplated as would normally occur to one skilled in the art to which the invention relates.

Unless otherwise indicated, the drawings are intended to be read (e.g., arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

Further, all numbers expressing dimensions, physical characteristics, and so forth, used in the specification and claims are to be understood as being modified in all instances by the term “about”. Accordingly, unless indicated to the contrary, the numerical values set forth in the following specification and claims can vary depending upon the desired properties sought to be obtained by the practice of the invention. At the very least, and not as an attempt to limit the application of the doctrine of equivalents to the scope of the claims; each numerical parameter should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 6.3, or 5.5 to 10, or 2.7 to 6.1.

For the purposes of promoting an understanding of the principles of the present invention, reference will now be made to the embodiments illustrated in the drawings and specific language will be used to describe the same.

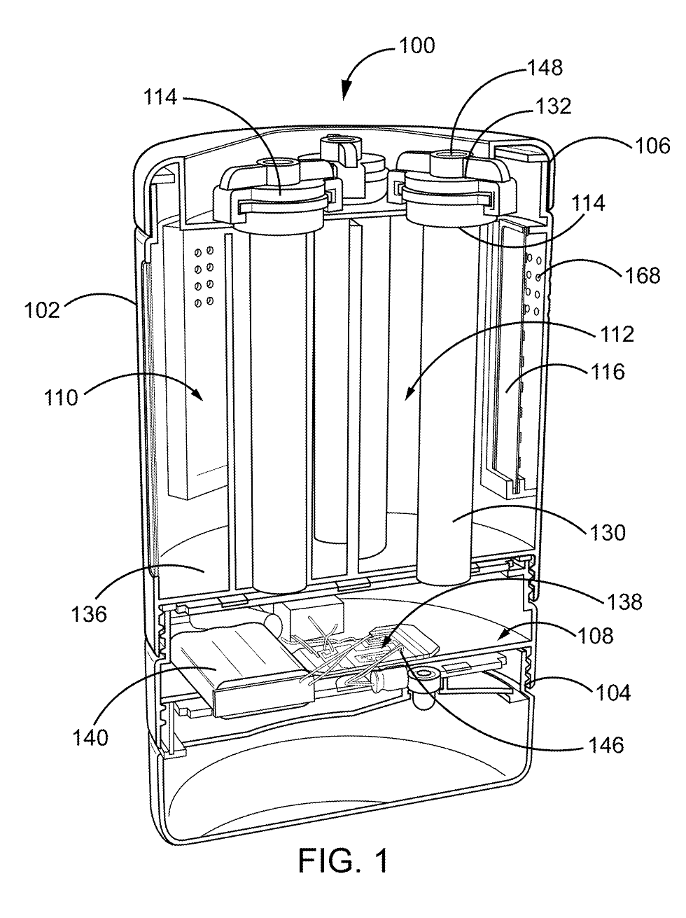

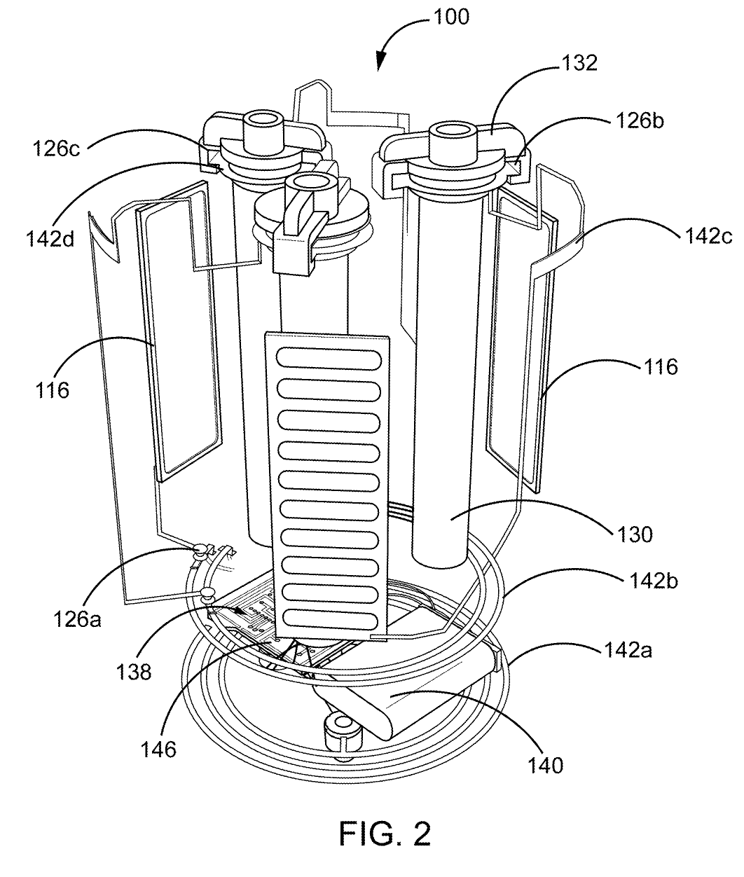

Referring to FIG. 1 and FIG. 2, a cross sectional view and an exploded view of a fuel cell 100 according to a preferred embodiment of the present invention is illustrated. The present embodiment discloses a fuel cell 100 designed to be integrated into a wide range of devices, comprising an outer casing 102, at least one cathode 116, at least one anode 130, an electrolyte 136, and a power module 138 with a charger 140 connected by means of a plurality of electrical connections 142a, 142b, 142c, 142d through a plurality of electrical contacts 126a, 126b, 126c to generate a direct current. In one embodiment, the outer casing 102 has a bottom end 104 and a top end 106 defining a bottom compartment 108 and a top compartment 110. The top compartment 110 is separated from the bottom compartment 108 that extends longitudinally defining an interior space 112 with at least one slot 114 on the top end 106. There need not be two compartments. The outer casing 102 may be made of plastic or any other suitable material known in the art.

Again, in this embodiment, the at least one cathode 116 is positioned at the interior space 112 and attached to the top compartment 110. The at least one anode 130 may be positioned longitudinally in the interior space 112 of the top compartment 110 by inserting it through the at least one slot 114. The at least one anode 130 may be attached to the outer casing 102 by means of a retainer 132 with a ring 134 or any other suitable means of attachment known in the art. The at least one anode 130 may be fitted to a bayonet-style retainer made of plastic with the ring having an “O” shape or any other type of seal, and is designed to be very easily changed when the anode gets exhausted.

The storage capacity of the anode 130 is dependent on the alloy blend but may be around 1.2 watts per gram. The at least one anode 130 of the fuel cell 100 may be made of Magnesium or a Magnesium alloy. The electrolyte 136 is filled in the top compartment 110 of the outer casing 102. The electrolyte 136 is in contact with the at least one cathode 116 and the at least one anode 130. The electrolyte 136 solution comprises at least one aqueous solution, such as a saline solution, a brine solution, seawater, or any other aqueous solution containing a metal salt (not limited to sodium chloride), including any biological saline fluid. The electrolyte solution further comprises a pH in a range of approximately 6 to approximately 9, and preferably approximately 7 to approximately 8. In a preferred embodiment, the electrolyte solution comprises a salt concentration in a range of approximately 3% to approximately 12% by weight. In the process, the anode member 5 is eventually consumed in a chemical reaction occurring in the electrolyte solution.

A power module 138 with a charger 140 may be positioned in the bottom compartment 108 and coupled electrically with the at least one cathode 116 and the at least one anode 130 by means of a plurality of electrical connections 142a, 142b, 142c, 142d through a plurality of electrical contacts 126a, 126b, 126c. Due to the presence of a corrosive electrolyte, the plurality of electrical connections 142a, 142b, 142c, 142d and the plurality of electrical contacts 126a, 126b, 126c are provided to ensure better connection and may be gold plated to prevent corrosion. The power module 138 may supply, or assist in supplying the required power when connected with a load. The power module 138 may include a DC-to-DC convertor 146 to boost the low fuel cell voltage to useful voltage levels according to the load connected. The Mg-Air cell of the present embodiment which may use Mg or Mg alloy as the at least one anode 130, when immersed in the electrolyte 136 coupled with the at least one cathode 116 generates a direct current. The at least one anode 130 is eventually consumed in the reaction.

A number of cathodes and anodes can be connected in a series and be used in combination to get a required output according to the load connected. In an exemplary embodiment, as shown in FIG. 1 and FIG. 2, a combination of three anode and three cathodes connected in series are utilized to get a an open circuit voltage of about 4.5 VDC and about 3-3.5 VDC under LED load. Hence, a DC-to-DC convertor 146 is not required to run the LEDs. Depending on the number of anodes and cathodes used, a DC-to-DC converter may be required to boost the cell voltage of 1.0 to 1.5 VDC to approximately 3.3 VDC. In one or two anode and cathode combination, a DC-DC converter is required.

When the at least one anode 130 is placed into the electrolyte 136 through the at least one slot 114, a chemical reaction starts immediately and may produce (depending on the materials used) Magnesium hydroxide and an excess of electrons at the at least one anode 130. The Oxygen from the air trapped in the fuel cell 100 through an air access vent 168 near the at least one cathode 116, or principally through the cathode's air permeable but hydrophobic membrane, reacts with the electrolyte 136 and produces hydroxyl (OH) ions and a depletion of ions at the at least one cathode.

The discharge reactions for the Mg-Air cell are as follows:

Anode Reaction: Mg-2e₋+2H₂O→Mg(OH)₂+2H⁺

Cathode Reaction: 1/2O₂+H₂O+2e₋→2OH

Overall Reaction: Mg+2H₂O→Mg(OH)₂+H₂(gas)

When a load is attached to the fuel cell such as an LED, electrons will flow though the circuit until the at least one anode 130 is exhausted. Small amounts of Hydrogen may be vented to the atmosphere through an air relief vent 148 on the retainer 132 and Magnesium Hydroxide accumulates in the electrolyte 136. The electrolyte 136 may need to be replaced approximately every 30 hours of use. The at least one anode 130 may be quickly and easily changed via the at least one slot 114 and held firmly to the outer casing 102 by means of a retainer 132. The fuel cell 100 does not release any toxic or hazardous byproducts into the environment.

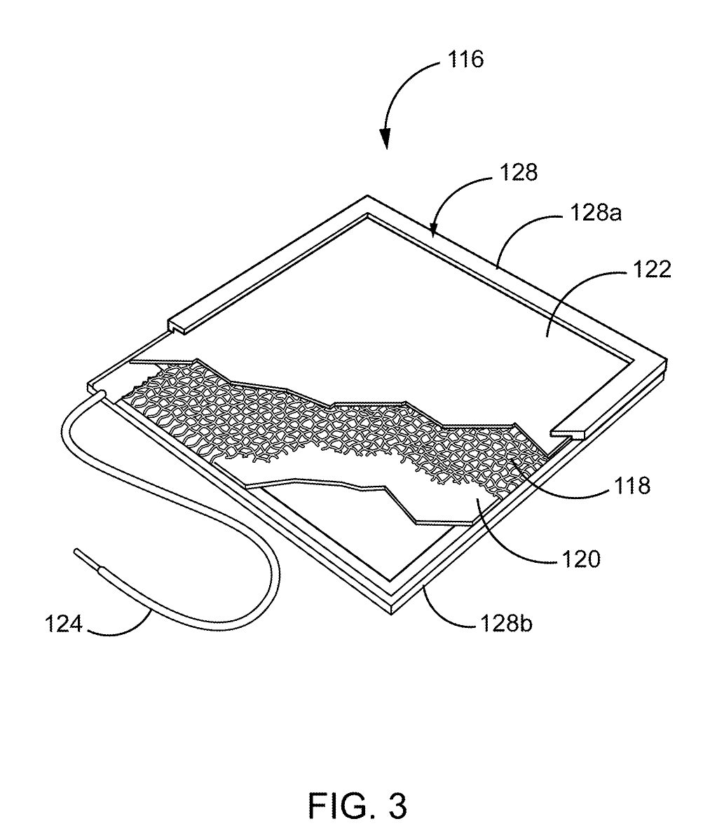

FIG. 3 illustrates a partially cut away view of the at least one cathode 116 according to the preferred embodiment of the present invention. The at least one cathode 116 may comprise a metal mesh 118 sandwiched in a carbon layer 120 having a hydrophobic layer 122. The metal mesh 118 is sandwiched in Nano scale particles of carbon to yield large surface area per volume, to potentially produce a high 20 mA per cm² of current carrying capacity. The carbon may be mixed with a small amount of hydrophobic particles such as expanded polytetrafluoroethylene (e-PTFE) to facilitate exchange of Oxygen from the atmosphere and discharge of Hydrogen from the top compartment 110.

The at least one cathode 116 may comprise carbon Nano-particles such as a fullerene, wherein the fullerene comprises at least one of a hollow icosahedral structure, hollow spherical structure, a hollow ellipsoidal structure, and a hollow tubular structure. The hollow spherical structure comprises a Nano-sphere, wherein the Nano-sphere comprises a buckyball. The hollow tubular structure comprises a Nano-tube, wherein the Nano-tube comprises a buckytube. The fullerene comprises at least one configuration, such as a pentagonal carbon ring, a hexagonal carbon ring, and a heptagonal carbon ring. The Nano-tube comprises at least one of configuration, such as a zigzag configuration, an armchair configuration, or a chiral configuration.

A connecting wire 124 may be attached to the metal mesh 118 to provide an electrical contact 126. The metal mesh 118 may be used to facilitate even current carrying distribution or as a retainer for the carbon Nano-particles. A two-part frame 128 having a front frame member 128a and a back frame member 128b, which may be made from plastic holds the metal mesh 118 and the carbon layer 120 together. A cleaned, crimped, and welded edge of a connecting wire 124 may also be soldered or cemented with conductive epoxy or alternate conductive adhesive and attached to the metal mesh 118 to guarantee excellent electrical contact. The at least one cathode 116 is pressed into the two part frame 128 to ensure a robust seal along the edges of the at least one cathode 116, including bonding to the connecting wire 124 as well as the carbon layer 120, the hydrophobic layer 122, and the conductive metal mesh 118. The two part frame 128 can be attached with the at least one cathode 116 by employing any of the methods selected from a group consisting of: ultrasonic welding, using a chemical solvent, using an adhesive and over molding, or any other method known in the art. Over molding is a method in which molten plastic is flowed over the edges of the at least one cathode 116 during the molding process.

Different types of cathodes have been utilized by others in the related art; however, these related art cathodes have short life times leading to electrolyte leakage, corrosion, and failure of the related art fuel cell. In solving some of these related art concerns, the present disclosure further contemplates several techniques for attaching the connecting wire to cathode member 116 by removing the carbon layer 120 from the metal mesh sheet 118 via a blast of compressed gas, such as nitrogen or air. Another method is to insert a grid of fine wires matching the holes in the metal mesh 118 to dislodge the carbon particles to provide a clean surface for attaching a connecting wire 124. Many other methods are possible, the two mentioned are just examples. As stated, this manufacturing technique further comprises attaching a connecting wire 124 to a cleaned edge of the metal mesh sheet 118. This may also be accomplished in a variety of ways of which the following are only examples: by way of a crimped structure, a welded structure, or a soldered structure for insuring an excellent contact. The hydrophobic layer 122, the metal mesh sheet 118, and carbon sheet formation 120 are pressed together into a two-part frame such that an excellent seal is made along the edges of the sandwich structure. Pressing together the hydrophobic layer 122, the metal mesh sheet 118, and the carbon sheet formation 120 into the two-part frame 128 may comprise at least one technique, such as ultrasonic welding and a chemical solvent etch and/or in combination with an adhesive bonding. By integrating the fuel cell 100 with an electronic device, such as a lighting device, e.g., a flashlight or a power module, using the foregoing techniques of fabrication method steps, many related art concerns are eliminated, such as cost, weight, and unreliability arising from an inordinate number of housing portions.

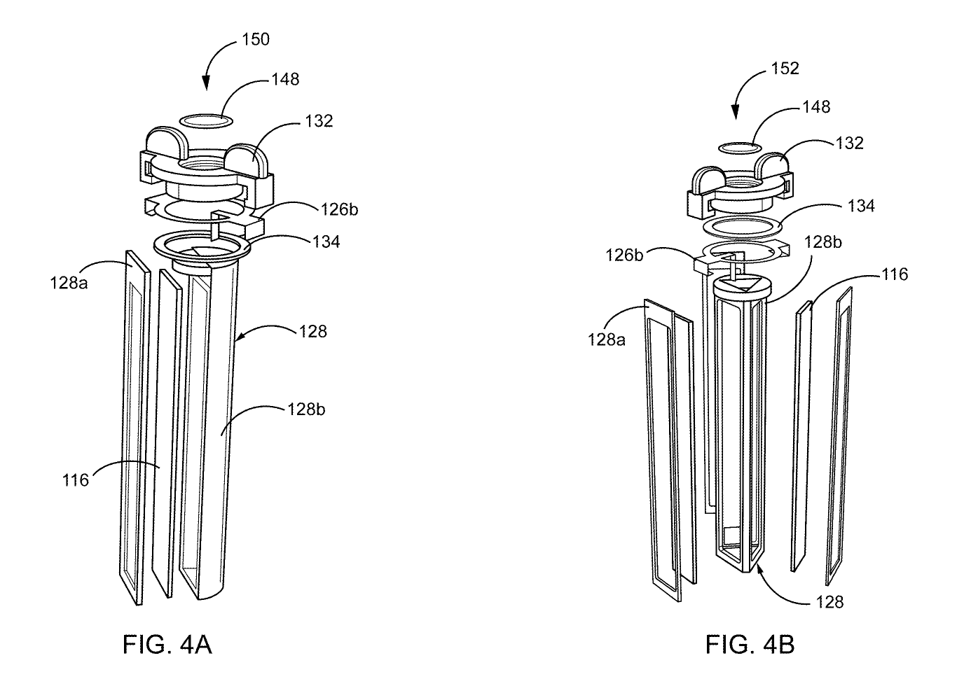

FIGS. 4A-4B illustrate an exploded view of a single replaceable cathode assembly 150 and a multiple replaceable cathode assembly 152 according to a preferred embodiment of the present invention. In the event that the cathode of a cell is punctured or damaged, the entire cell is rendered useless. The at least one cathode 116 as illustrated in the present embodiment is easily replaceable and adds to the reliability of the fuel cell. FIG. 4A illustrates a single removable cathode assembly 150 with one replaceable cathode 116 and FIG. 4B illustrates a multiple replaceable cathode assembly 152 with three replaceable cathodes 116. In this embodiment, the at least one replaceable cathode 116 may be placed inside the two part frame 128 with the front frame member 128a and the back frame member 128b. As the chemical reaction starts, electrons will flow though the circuit via the at least one electrical contact 126b and small amounts of Hydrogen are vented to the atmosphere through a gas relief vent 148 on a retainer 132 having a ring 134. The gas relief vent 148 may be made from e-PTFE or similar gas permeable membrane such that H2 created can safely be vented out while the electrolyte 136 is retained in the top compartment 110.

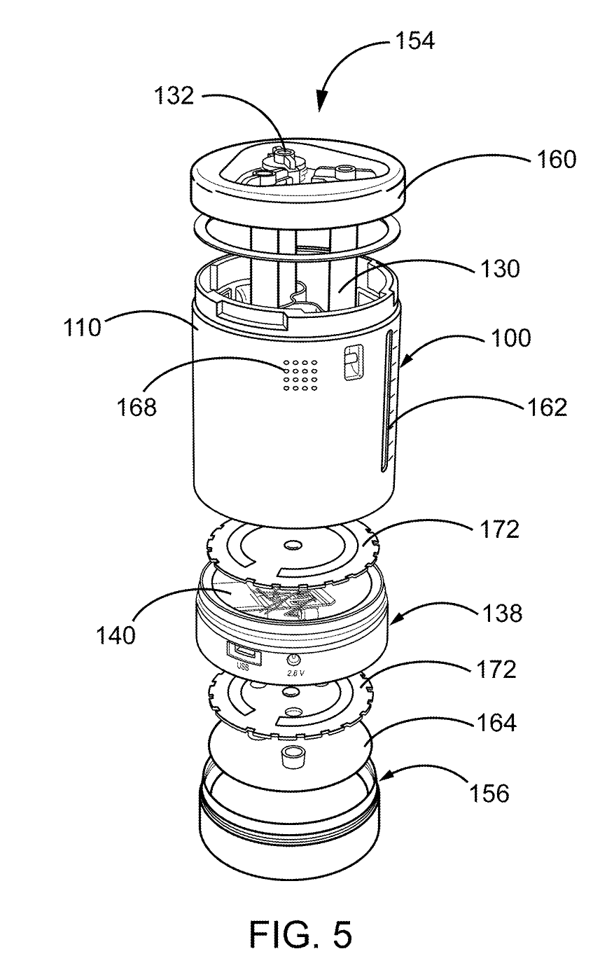

FIG. 5 illustrates an exploded view of one embodiment of the fuel cell 100 according to the present invention in use with a lantern 154. The lantern 154 is designed for overhead hanging as in a tent, hut, or room. It is designed to cast a wide area light for general illumination or a narrower beam to concentrate the light for specific tasks like reading, sewing, or precision work. The lantern 154 can also be placed upside down on a table for general-purpose lighting that is more concentrated. The lantern 154 comprises a fuel cell 100 having a high-discharge power module 138 with the charger 140 and a lamp module 156 having a reflector 164 that uses high efficiency LED(s) for lighting.

In the present embodiment, the lantern 154 utilizes a combination of three anodes and three cathodes to provide the required voltage for lighting the LED(s). In the present embodiment, the top compartment 110 has curved compartments to store the electrolyte 136 which is held inside and easily sealed by a lid 160. The at least one anode 130 is placed firmly and aligned next to the at least one cathode 116 in a novel manner. The at least one anode 130 attached with a retainer 132, is easily accessible for rapid replacement. The lid 160 can be removed to provide an easy means to fill the top compartment 110 with the electrolyte 136 or rinse out the top compartment 110 of any MgOH residue. The air access vent 168 for the at least one cathode 116 is provided on the outer casing 102. The plurality of connections 142a, 142b and 142c are powered by 5 volts from the DC-DC converter 146 or from the fuel cell 100 through a pair of connection contact plates 172 so that the lantern may be used or sold without the charger 140.

A clear level indicator 162 is present on the outer casing 102 to indicate the level of the electrolyte 136 for reliable operation. The level indicator 162 also indicates if the electrolyte 136 needs to be changed by showing the amount of MgOH present. The electrolyte 136 turns milky white and indicates that the electrolyte 136 needs to be changed.

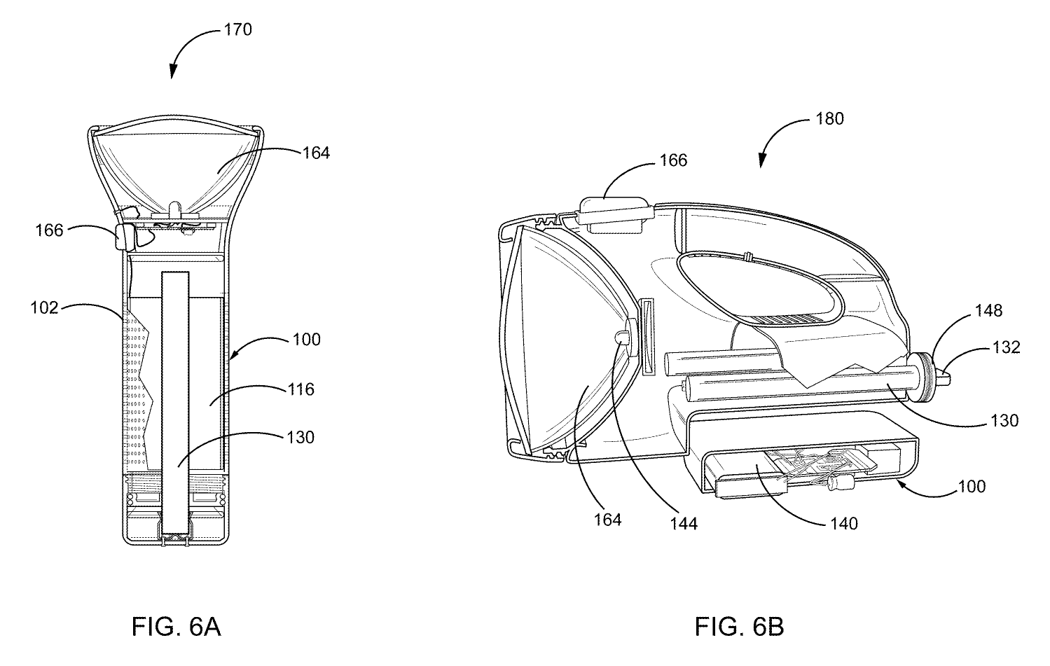

FIG. 6A illustrates a cross sectional view of one embodiment of the fuel cell 100 according to the present description in use with a small flashlight 170. The at least one cathode 116 and the at least one anode 130 may be retained by a retainer 132 in a top compartment 110. A bottom compartment 108 may contain a power module 138 to supply power for an LED. A ring 134 may cushion and protect the power module 138 from the electrolyte 136. In the present embodiment, the at least one cathode 116 exchange air (02 actually) and vent Hydrogen to the atmosphere through the air relief vent 148. The reflector 164 is designed to maximize the light output from one or more LEDs. The Mg-Air cell used in these designs requires a means for the cathode to exchange air (02 actually) and vent Hydrogen. The lid 160 which when unscrewed provides access to the electrolyte 136 filled and the cathode 116. The small flashlight 170 may have an ON/OFF switch 166 on the outer casing 102.

FIG. 6B illustrates a cross-sectional view of one embodiment of the fuel cell 100 according to the present invention in use with a large flashlight 180. The large flashlight 180 has an integrated Mg-Air cell fuel cell that may employ two or more anodes and cathodes to provide more power and a higher voltage than the small flashlight. The large flash light 180 has the reflector 164, shown with a medium spot beam means, although other types of reflector can be substituted such as extreme spot for longest range, or wide angle for broader coverage, nearby. The ON/OFF switch 166 may be utilized to push to high power or low power to enable flashing ON and OFF. An air relief vent 148 on the retainer 132 vents out Hydrogen formed during the fuel cell 100 operation. The at least one anode 130 can be replaced by turning a retainer 132. A retainer 132 allows for fast exchange of worn anodes. The charger 140 features appropriate charge control like overcharge protection, over temperature protection, low voltage shutoff, a “gas gauge” circuit as well as LED or other means of monitoring these parameters. The load 144 is the LED or LEDs that are selected for maximum light output and efficiency.

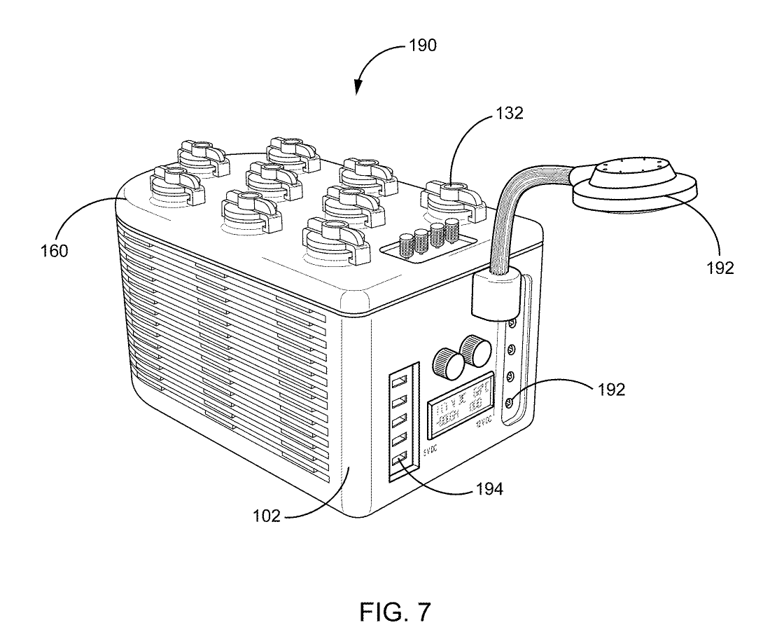

FIG. 7 illustrates a perspective view of one embodiment of a fuel cell 100 according to the present invention in use with a lighted power module 190. The lighted power module 190 integrates a more powerful source of electricity than can be had with a hand-held flashlight, but still retains a useful general-purpose integrated LED light 192. The lighted power module 190 has an open circuit voltage of 13.5V, or about 12V under maximum load. The lighted power module 190 is utilized to power or charge a variety of portable equipment and has different regulated and unregulated voltages to run a variety of equipment. The lighted power module 190 has a plurality of USB type jack 194 with a regulated 5Volt and DC power jack 196 that can be set to different voltages depending on required service via internal voltage regulators. The lid 160 can be lifted off for easy filling and rinsing of the electrolyte 136. The retainer 132 with the ring 134 helps to replace the at least one anode 130 with a ¼ turn twist when the anode gets exhausted. The outer casing 102 of the present embodiment is the reinforced molded plastic, but metal may be used in case, if the lighted power module 190 is used for search and rescue, fire department or military operations.

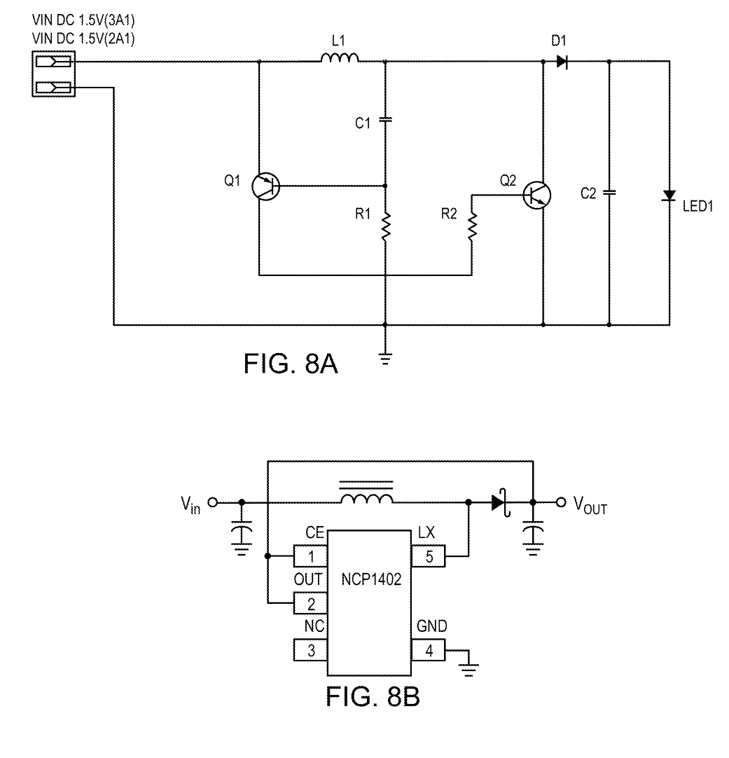

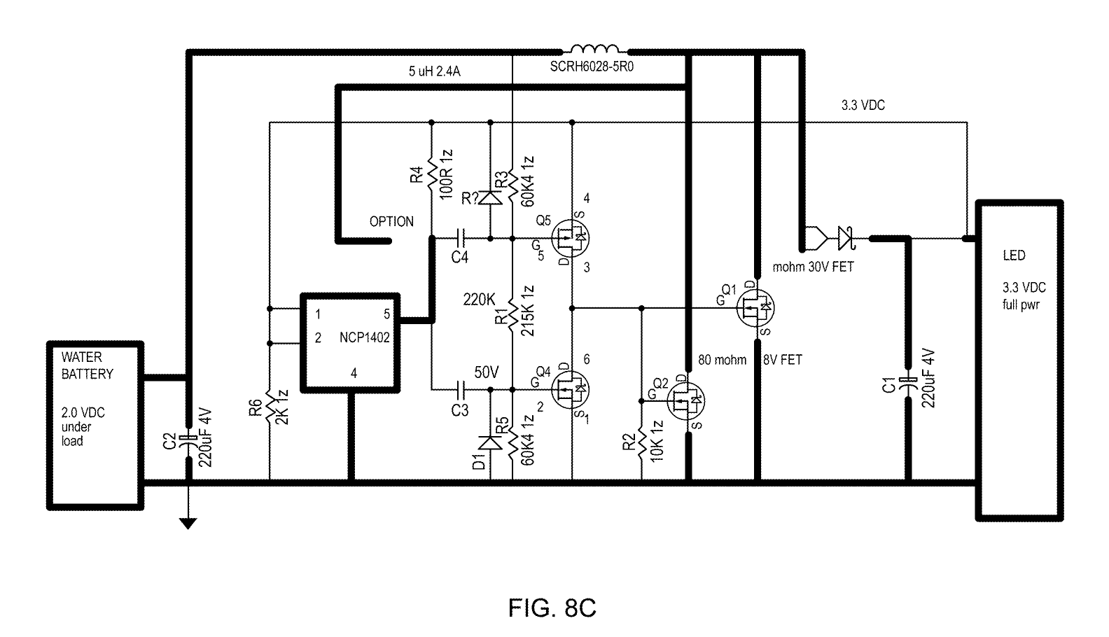

FIGS. 8A-8C illustrate a circuit diagram of a DC-DC convertor 146 to be used for low power, medium power, and high power fuel cell respectively according to the preferred embodiment to the present invention. The DC-DC convertor 146 is utilized to boost the fuel cell voltage in accordance to the load connected. In order to use the fuel cell 100 in flashlights or fuel cells, a DC-DC converter 146 is required due to the low fuel cell voltage of 0.7 to 1.5 VDC (under load) per cell. FIG. 8A illustrates the DC-DC convertor 146 to be utilized for a lower power circuit. The DC-DC convertor 146 to be utilized for a medium power circuit is illustrated in FIG. 8B and the DC-DC convertor 146 to be utilized for a high power circuit is illustrated in FIG. 8C.

The DC-DC converter circuits of the present disclosure have met the challenges presented by a limitation of current transistor technology in the related art, such limitation being approximately 0.6 V. A typical silicon transistor (2N3904) collector-emitter saturation voltage, VCE(sat), under load, may be approximately 0.3 V; and its base-emitter saturation voltage, VBE(sat), may be approximately 0.95V. Field effect transistors (FETs) also typically operate poorly at low voltages; and their static drain-source on-resistances (RDSon) are rarely specified below approximately 1 V. A very popular FET, a 2N7000, is a case in point as its gate threshold voltage is typically quoted at approximately 1.2 V. Working over a wide temperature range is also a problem due to the effect of heat and to a lesser extent cold on these semiconductor parameters.

In addition to having a DC-DC converter circuit that operates at this low voltage, efficient operation is essential so that most of the power goes to the load and not merely dissipated in the converter. The DC-DC converter circuits of the present disclosure have met the efficiency challenges as well. For instance, with a 50% efficient converter, a 200-hour anode lifetime is decreased by one half, because twice as much current must be drawn to compensate for the converter losses. Alternatively, with a 50% efficient converter, a device would experience only half the power being output to the load. Further, the DC-DC converter circuits have met the power adequacy challenges as well, e.g., overcoming the related art difficulty in providing adequate power at low voltages to drive LEDs or other loads, such as a cell phone charger, to proper levels while retaining the converter's efficiency. Furthermore, the DC-DC converter circuits have met the economic challenges by being affordably manufactured.

Referring to FIG. 8A, this circuit diagram illustrates a DC-DC converter circuit for a Mg-air fuel cell which provides significantly low cost for low power in a range of less than or equal to approximately 100 mW, in accordance with an embodiment of the present disclosure. This circuit is known as a “Multivibrator” type and is optimised for best efficiency.

Referring to FIG. 8B, this circuit diagram illustrates a DC-DC converter circuit for a Mg-air fuel cell which provides significantly low cost and high efficiency for low power in a range of less than or equal to approximately 250 mW, in accordance with an embodiment of the present disclosure. This circuit benefits from a specialized integrated circuit. Each device comprises one of an on-chip PFM (Pulse Frequency Modulation) oscillator, a PFM controller, a PFM comparator, a soft-start, voltage reference, a feedback resistor, a driver, and a power MOSFET, and a switch with current limit protection. Additionally, a chip enable feature is provided to power down the converter for extended fuel cell life. This particular Integrated circuit is made by ON semiconductor; however, other circuits with a similar list of functions may be substituted.

Referring to FIG. 8C, this circuit diagram illustrates a DC-DC converter circuit for a Mg-air fuel cell which provides significantly low cost and high efficiency for high power in a range of less than or equal to approximately 1.5 Watts, in accordance with an embodiment of the present disclosure. By example only, in order to power a 3.3-VDC LED via a Mg-air fuel cell, a boost circuit, such as the DC-DC converter circuit, capable of providing power from a range of less than approximately 1 VDC is employed, in accordance with this embodiment. As most semiconductors have minimum operating requirements of approximately 0.6V, operation of a boost converter becomes challenging. To optimize efficiency, the solid-state switch, a field effect transistor (FET) that creates the boost, comprises a low effective resistance when the switch is in the “on” position (RDSon) and is capable of being driven with a high-dV/dt gate drive. Other challenges that are met by the DC-DC converter circuit of the present disclosure include the lower RDSon FETs having both a high-input gate capacitance and a maximum guaranteed operating voltage of approximately 2.5 V, the requirement for a combination of a fast gate drive and a minimum gate drive voltage of approximately 2.5 V being difficult from a range of less than approximately 1V source, and a circuit continuing until a input voltage decreases to a range of less than approximately 0.6 VDC after the NCP1402 boost circuit causes the output voltage to be approximately 3.3 VDC. The solution offered by the DC-DC converter circuit combines a solid-state device that operates at low voltages in a range of less than approximately 1 V with a low RDSon FET, thereby optimizing the overall boost efficiency. The problems of high dV/dt guaranteed 2.5-gate drive are resolved by using the DC-DC converter circuit, comprising a NCP1402 boost circuit with a small dual FET, thereby effecting a boost voltage in a range of greater than approximately 2.5 V, and thereby enabling the lower RDSon FET to continue boosting.

Information as herein shown and described in detail is fully capable of attaining the above-described object of the present disclosure, the presently preferred embodiment of the present disclosure; and is, thus, representative of the subject matter; which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the present disclosure.

1. A fuel cell, comprising:
a casing with a wall and an interior space and an exterior space;
a flat or curved cathode;
an anode; and
a bayonet-style retainer removably attaching the anode to the retainer, where the anode is positioned longitudinally in the interior space.

2. The fuel cell of claim 1, wherein said anode comprises magnesium or a magnesium alloy.

3. The fuel cell of claim 1, wherein said cathode is removably attached to a wall of said casing.

4. (canceled)

5. The fuel cell of claim 1, wherein at least one of said flat or curved cathodes is removably attached to the casing with another bayonet-style retainer.

6. (canceled)

7. The fuel cell of claim 1, wherein said retainer is cylindrically shaped and seals its removable attachment to said casing with an O-ring.

8. The fuel cell of claim 1, wherein said retainer has a gas release vent for releasing hydrogen to the exterior space.

9. The fuel cell of claim 8, wherein said gas release vent is hydrophobic.

10. The fuel cell of claim 1, further comprising:
wiring;
wherein said wiring contacts at least one anode and at least one cathode with a plurality of electrical connections.

11. The fuel cell of claim 10, wherein at least some of said wiring comprises the metal gold or gold alloys or equally resistant alloy or metal to the effects of an electrolyte having a saline concentration ranging from approximately 3% to approximately 12% by weight.

12. The fuel cell of claim 1, wherein the cathode further comprises:
one or more metal mesh layers;
one or more carbon layers;
one or more hydrophobic layers.

13. The fuel cell of claim 12, wherein said metal mesh is between two or more of said carbon layers.

14. The fuel cell of claim 12, wherein said carbon layer further comprises carbon fullerenes.

15. The fuel cell of claim 12, further comprising:
a frame;
wherein said frame holds said metal mesh, said carbon layer, and said hydrophobic layer together.

16. The fuel cell of claim 1, further comprising:
an indicator on said casing for determining how much fluid is in the interior of said casing.

17. The fuel cell of claim 1, further comprising:
a hydrogen release vent on said casing.

18. The fuel cell of claim 1, further comprising:
a DC-to-DC converter circuit.

19. The fuel cell of claim 1, further comprising:
a power module with a charger.

20. The fuel cell of claim 1, further comprising:
a power outlet.
